(19) United States
(12) Patent Application Publication
(10) Pub. No.: US 2026/0351685 A1
(43) Pub. Date: Nov. 5, 2026

(54) Electrode Winding for an Energy Storage Cell, Energy Storage Cell and Method for Producing Same

(71) Applicant: BAYERISCHE MOTOREN WERKE AKTIENGESELLSCHAFT, Muenchen (DE)

(72) Inventor: Roland JUNG, Muenchen (DE)

(21) Appl. No.: 19/125,556

(22) PCT Filed: Oct. 26, 2023
(86) PCT No.: PCT/EP2023/079863

§ 371 Date: Apr. 29, 2025

(30) Foreign Application Priority Data
Nov. 8, 2022 (DE) 10 2022 129 522.2

(51) Int. Cl. H01M 10/0587; H01M 50/107; H01M 50/213

(52) U.S. Cl. CPC H01M 10/0587; H01M 50/107; H01M 50/213

(57) ABSTRACT

An electrode winding for an energy storage cell includes a first electrode having a first current collector including an electrically conducting material impermeable to ions during operation of the energy storage cell, the first current collector having two opposite sides, each coated with a first active material in which ions can be embedded; a second electrode having a second current collector including a second electrically conductive material impermeable to ions during operation of the energy storage cell, the second current collector having two opposite sides, each coated with a second active material in which ions can be embedded; a separator, arranged between the first and second electrodes, by which the first and second electrodes are electrically insulated, wherein the first current collector has a first region which is permeable to ions, so that ions pass from one to the other of the sides of the first current collector.

### BACKGROUND AND SUMMARY

The present disclosure relates to an electrode winding for an energy storage cell, an energy storage cell and a method, in particular a computer-implemented method, for producing an electrode winding. The present disclosure further relates to a battery module having such energy storage cells and a motor vehicle having such a battery module.

In the field of energy storage cells, in particular battery cells, in particular lithium ion battery cells, cylindrical, prismatic and pouch-shaped battery cells are primarily known. Battery cells to store electrical energy play a central role in the field of so-called electric mobility and in vehicles with a pure electric drive and also in vehicles with a hybrid drive. For example, a battery module for a 12 V starter battery can have four battery cells, whereas a high-voltage store can have a plurality of battery modules. Cylindrical lithium ion battery cells can have an electrode winding, in which the electrodes including separators in the sequence separator-anode-separator-cathode are wound spirally around a winding core.

The electrodes can have a mixture of active material, binder and conductive additives. This mixture can be applied as a thin layer on both sides of a current collector. The coating can be carried out on both sides either with an identical loading (symmetrical coating) or a slightly different loading (asymmetrical coating). It is necessary that the ratio of the capacity per unit area (in mAh/cm²) from anode to cathode (N/P ratio) is greater than 1, in order to prevent “lithium plating”. At the same time, the N/P ratio should not be too great either, in order to keep irreversible lithium losses as a result of so-called SEI (solid electrolyte interface) formation on the anode as low as possible.

Because of the spiral winding of the electrode winding, the result is that the respective outer electrodes can supply or take up a greater capacity than the inner electrodes located opposite thereto, because of the larger radius. This leads to a deviation in the desired N/P ratio. The deviation from this N/P ratio is at the highest in particular in the innermost windings, for purely geometric reasons. In order to reduce the deviation in the innermost windings, the front and rear side of at least one electrode can be coated with a slightly different loading (asymmetrical coating). An asymmetrical coating is, however, more complicated to produce from a process point of view than a symmetrical coating, since the loading on the front and rear side must be different and the two sides should always be clearly assignable. This assignment, for example by a visual check, is possible only with difficulty.

It is an object of the present disclosure to specify an electrode winding for an energy storage cell, an energy storage cell, a battery module, a motor vehicle and a method which is or are improved with regard to the aforementioned problems.

This object is achieved by an electrode winding according to the present disclosure, an energy storage cell, a battery module having such energy storage cells, a motor vehicle having such a battery module and a method for producing an electrode winding.

A first aspect of the solution relates to an electrode winding for an energy storage cell, having: (i) a first electrode having a first current collector, which comprises a first electrically conductive material that is impermeable to ions during operation of the energy storage cell; (ii) wherein the first current collector has two opposite sides, which are each coated with a first active material in which ions, in particular lithium ions, can be embedded; (iii) a second electrode having a second current collector, which comprises a second electrically conductive material that is impermeable to ions during operation of the energy storage cell; (iv) wherein the second current collector has two opposite sides, which are each coated with a second active material in which ions can be embedded; (v) a separator, which is arranged between the first electrode and the second electrode, by which the first electrode and the second electrode are electrically insulated from one another; (vi) wherein the first current collector has a first region which is permeable to ions, so that the ions can pass from one to the other of the two opposite sides of the first current collector.

The terms “comprises,” “contains,” “includes,” “has,” “with,” or any other variant thereof possibly used here are intended to cover a non-exclusive incorporation. Thus, for example, a method or a device which comprises or has a list of elements is not necessarily restricted to these elements but can include other elements which are not expressly listed or which are inherent to such a method or such a device.

Furthermore, if the opposite is not expressly specified, “or” relates to an inclusive or and not to an exclusive “or”. For example, a condition A or B is fulfilled by one of the following conditions: A is true (or present) and B is false (or not present), A is false (or not present) and B is true (or present), and both A and B are true (or present).

The terms “a” or “one” as used here are defined in the sense of “a/one or more.” The terms “another” and “a further” and every other variant thereof are to be understood in the sense of “at least one further.”

The term “plurality” as used here is to be understood in the sense of “two or more.”

The term “configured” or “set up” to fulfil a specific function (and respective modifications thereof) as used here is to be understood such that the corresponding device is already present in a configuration or setting in which it can carry out the function or it can at least be set up—i.e. configured—in such a way that it can carry out the function in accordance with the corresponding setting. The configuration can be made, for example, via a corresponding setting of parameters of a process sequence or switches or the like for activating or deactivating functionalities or settings. In particular, the device can have a plurality of predetermined configurations or operating modes, so that the configuration can be made by a selection of one of these configurations or operating modes.

The term “electrode winding” as used here is to be understood in particular to be a device which, as a subassembly of a galvanic cell, in particular a battery cell, is also used for storing chemical energy and for discharging electrical energy. To this end, the electrode winding has at least two electrodes, namely an anode and a cathode, and a separator, in particular an electrically insulating separator, which can at least partly accommodate an electrolyte. The anode, separator and cathode are wound around an axis to form an electrode winding. The separator is arranged between the anode and cathode, so that the anode and cathode are electrically insulated with respect to one another. As a result, a repeating sequence of separator-anode-separator-cathode is formed in the electrode winding. Before the discharge of electrical energy, stored chemical energy is converted into electrical energy. During the charging of the cell, the electrical energy supplied to the electrode winding is converted into chemical energy and stored. The electrodes can have a current collector, in particular made of Al for the cathode and of Cu for the anode, wherein a thin layer made of a mixture of active material, binder (e.g. PVDF, PTFE, CMC, SBR, Li-PAA, PAA, etc.) and conductive additives (carbon black, CNTs, carbon fibers, etc.) can be applied to both sides of the current collector. The current collector can in particular be formed as a foil.

The term “active material” as used here is to be understood in particular to be a material which can be electrochemically active and which is suitable for coating electrodes for electrode windings for battery cells and in which ions, in particular lithium ions, can be embedded. The active material for the cathode can in particular include NMC, NCA, NCMA, LCO, LFP, LMFP, LMO, LMNO or else another material. The active material for the anode can in particular include graphite, SiOx, SiC, Si, Sn, SnOx or another material.

The term “separator layer” or a “separator” as used here is to be understood in particular to be an electrically insulating device which separates and spaces an anode apart from a cathode. Preferably, a separator layer is applied to an anode layer and/or a cathode layer. Preferably, the separator layer is formed as an independent body. The separator layer or the separator can also at least partly accommodate an electrolyte, wherein the electrolyte preferably contains lithium ions. The electrolyte can also be electrochemically operatively connected to adjacent layers of an electrode stack or electrode winding. Preferably, the shape of a separator substantially corresponds to the shape of an anode of the electrode stack. Preferably, a separator is thin-walled, particularly preferably formed as a microporous film. Preferably, the separator layer or the separator is wetted with an additive, which also increases the mobility of the separator layer or of the separator. Likewise, the separator can have a ceramic coating, in particular a base film which has polyethylene and a coating on one side or both sides with, for example, Al₂O₃ and a so-called binder. Particularly preferably, the wetting is carried out with an ionic additive. Preferably, the separator layer or the separator extends in at least some regions beyond a boundary layer of at least one electrode. Particularly preferably, the separator layer or the separator extends beyond all the boundary edges of adjacent electrodes.

The term “electrolyte” as used here is to be understood as a liquid or solid material through which ions can be conducted, as a result of which a transport of current between electrodes of the battery, in particular between a cathode and an anode, is made possible. As distinct from the electronic conductivity (by electrons) in the electrode materials, the electrolyte must be ionically conductive, i.e. conduct the electrical current by transporting charged atoms or molecules (ions). The electrolyte is advantageously chemically stable in a wide temperature window and electrochemically stable with respect to decomposition in the largest possible voltage window. Ideally, it is non-toxic and noncombustible and has at least a high flame point and a low heat of combustion. Liquid systems may be preferred over polymer and solid electrolytes because of better conductivity.

By the electrode winding according to the first aspect, it is possible that during the operation of the energy storage cell by using an electrolyte, ions can pass from one side to the other side of the opposite sides of the first current collector through the permeable first region. As a result, it is possible to compensate for an unequal capacity of the opposite sides relative to one another, caused by an unequal area of an area arranged radially further in relative to the longitudinal axis than an area arranged radially further out.

Preferred embodiments of the electrode winding are described below, which can each be combined with one another and combined with the further other aspects described as desired, if this is not expressly ruled out or technically impossible.

In some embodiments, the first region is formed in a first end region of the first current collector, radially adjacent to the longitudinal axis. As a result, the action of the compensation can be intensified, since the ratio of the areas is higher in the first end region than in areas arranged radially further out.

In some embodiments, the first end region has a first edge region for making electrical contact, which is impermeable to ions. As a result, the first edge region has additional material as compared with a permeable region and, as a result, can be better connected electrically to a further component, in particular via welding.

In some embodiments, the first end region has a first edge region for making electrical contact, which is permeable to ions. As a result, the first end region can be produced consistently.

In some embodiments, the first region has cutouts, in particular cutouts with a circular or square cross section. As a result, the ions can pass through the first current collector.

In some embodiments, the second current collector has a second region which is permeable to ions, so that the ions can pass from one to the other of the two opposite sides of the second current collector. As a result, during operation of the energy storage cell by using an electrolyte, ions can pass from one side to the other side of the opposite sides of the second current collector through the permeable first region. As a result, it is possible to compensate for an unequal capacity of the opposite sides relative to one another, caused by an unequal area of an area arranged radially further in relative to the longitudinal axis to an area arranged radially further out. Furthermore, a region permeable to ions is formed both in the first current collector and in the second current collector, as a result of which the capacities between the electrodes can be equalized better.

In some embodiments, the second region is formed in a second end region of the second current collector, radially adjacent to the longitudinal axis. As a result, the action of the compensation can be intensified, since the ratio of the areas in the second end region is higher than in areas arranged radially further out.

In some embodiments, the second end region has a second edge region for making electrical contact, which is impermeable to ions. As a result, the second edge region has additional material as compared with a permeable region and, as a result, can be electrically connected better to a further component, in particular by welding.

In some embodiments, the second end region has a second edge region for making electrical contact, which is permeable to ions. As a result, the second end region can be produced consistently.

In some embodiments, the second region has cutouts, in particular cutouts with a circular or square cross section. As a result, the ions can pass through the second current collector.

A second aspect of the solution relates to an energy storage cell, in particular a lithium ion battery cell, having a cylindrical cell housing in which an electrode winding according to the first aspect is arranged.

A third aspect of the solution relates to a battery unit having a plurality of energy storage cells according to the second aspect.

A fourth aspect of the solution relates to a system having an electric drive and a battery unit according to the third aspect. In particular, the system can have a motor vehicle, a mobile device or else a stationary device, such as a charge store in a building.

A fifth aspect of the solution relates to a method for producing an electrode winding for an energy storage cell, comprising the following steps: (i) producing a first electrode, comprising the step of coating opposite sides of a first current collector with a first active material in which ions can be embedded, wherein the first current collector has a first electrically conductive material which is impermeable to ions during operation of the energy storage cell, and wherein the first current collector has a first region which is permeable to ions, so that the ions can pass from one to the other of the two opposite sides of the first current collector; (ii) producing a second electrode, comprising the step of coating opposite sides of a second current collector with a second active material in which the ions can be embedded, wherein the second current collector (165) has a second electrically conductive material which is impermeable to ions during the operation of the energy storage cell (100); (iii) arranging a separator, the first electrode and the second electrode in a sequence separator, first electrode, separator, second electrode; (iv) winding this arrangement around a longitudinal axis.

In some embodiments, in a production step before the coating, the first current collector is separated from a current collector roll which is provided for a multiplicity of current collectors for a multiplicity of electrode windings, wherein the current collector roll has a first region that is permeable to the ions at equal intervals. As a result, multiple current collectors having a first region which is respectively permeable to ions can be produced more effectively.

The features and advantages explained with respect to the first aspect of the solution also apply in a corresponding way to the further aspects described.

Further advantages, features and possible applications can be gathered from the following description of preferred embodiments in conjunction with the figures.

### BRIEF DESCRIPTION OF THE DRAWINGS

FIG. 1 shows, schematically, a battery cell according to one embodiment;

FIGS. 2A to 2B each show, schematically, a detail of a coated first electrode of an embodiment;

FIGS. 2C to 2D each show, schematically, a detail of a coated second electrode of an embodiment;

FIG. 3 shows a flow chart to illustrate a preferred embodiment of a method.

### DETAILED DESCRIPTION OF THE DRAWINGS

In the figures, the same designations are used throughout for the same or mutually corresponding elements.

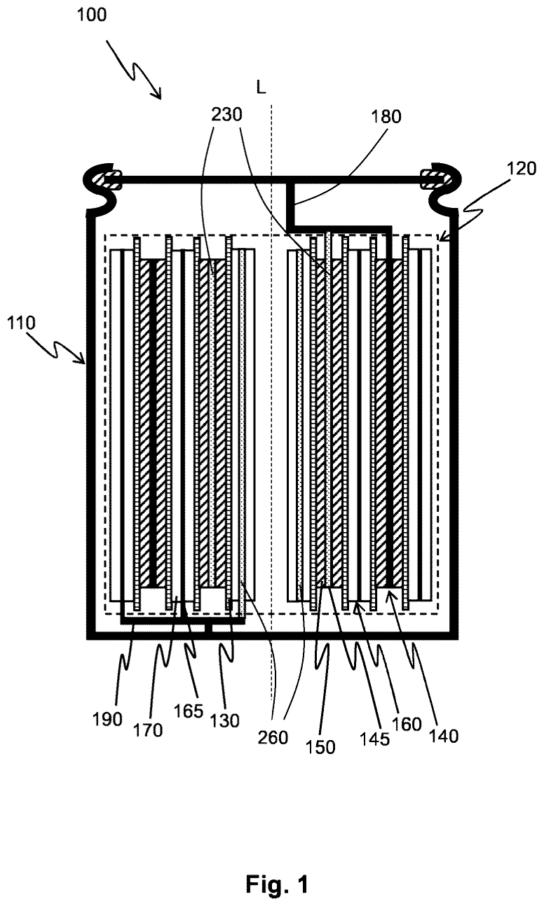

A battery cell 100 according to one embodiment is shown schematically in FIG. 1. The battery cell 100 has an electrically conductive cell housing 110. An electrode winding 120 is arranged in the cell housing 110. The electrode winding 120 has an electrode with a first, positive polarity 140, and an electrode with a second, negative polarity 160. The electrode winding 120 and the battery cell 100 could, however, also be constructed in such a way that the first polarity is negative and the second polarity is positive. The electrode winding 120 is arranged in the cell housing 110 such that electrodes of positive polarity 140 and negative polarity 160 are arranged alternately in the radial direction relative to a longitudinal axis L of the cell housing 110 and the electrode winding 120. Between the positively polarized electrode 140 and the negatively polarized electrode 160 there is arranged a separator 130, which has an electrically insulating material, so that the differently polarized electrodes 140, 160 are electrically insulated from one another. The positively polarized electrode 140 has a first current collector 145, which is coated on both sides with a first electrochemical active material 150. The negatively polarized electrode 160 has a second current collector 165, which is coated on both sides with a second electrochemical active material 170. The first current collector 145 and the second current collector 165 can each be formed as a foil. In this connection, a current collector formed as a foil is also designated as a collector foil below. The electrode winding 120 is arranged within the cell housing 110 such that the negative electrode 160 is electrically connected to the cell housing 110.

It is also conceivable that the electrode winding 120 is arranged within the cell housing 110 in an electrically insulating inner housing (not shown here), which electrically insulates the electrode winding 120 from the cell housing 110.

The positively polarized electrode 140 is electrically connected to a first metal plate 180. The negatively polarized electrode 160 is electrically connected to a second metal plate 190.

In FIG. 1, the battery cell 100 has, schematically, an electrode winding 120 with only two windings. The electrode winding 120 can, however, also have considerably more windings, in particular between 20 and 100 windings.

As a result of the geometry of the electrode winding 120, in which the electrodes of negative and positive polarity 140, 160 are wound spirally about a longitudinal axis L, the result can be an unfavorable ratio of the electrochemical active material 145 and the ions respectively embedded therein between the electrode of positive polarity 140 and the electrode of negative polarity 160. This is due to the fact that an area of the first collector foil 145 lying radially further out in relation to the longitudinal axis L has a larger area than an area lying further in, as a result of which different capacities can be formed in the respective areas.

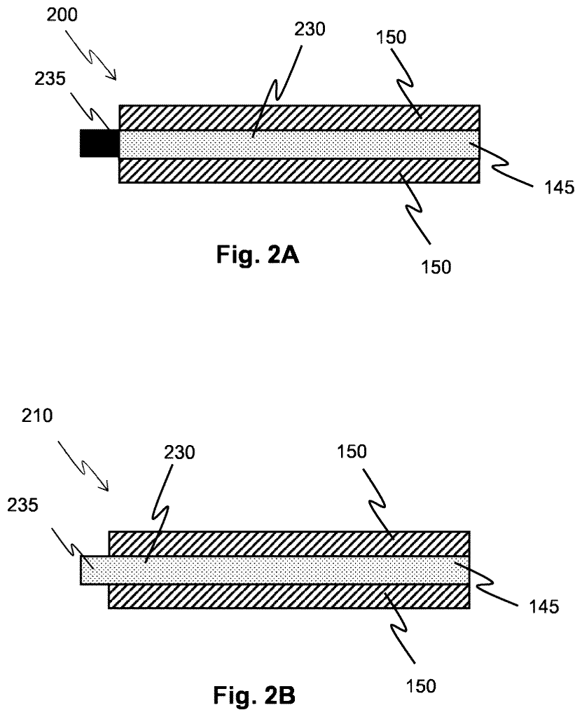

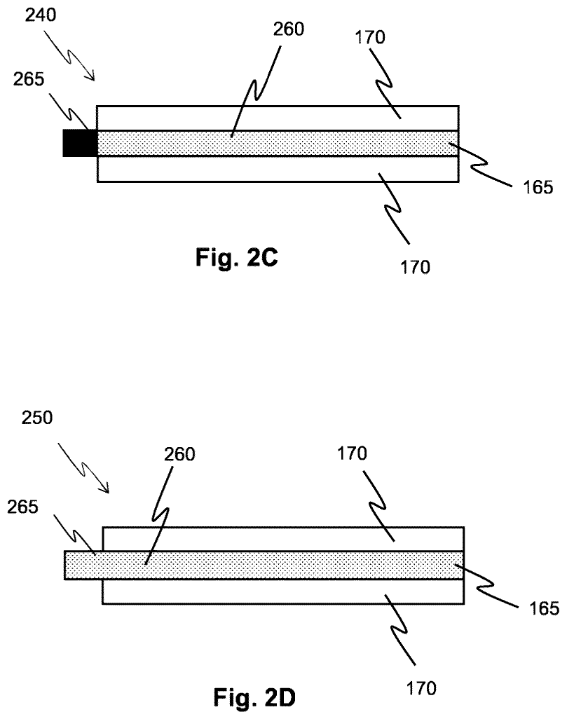

The first collector foil 145 has a first region 230 which is perforated and, as a result, is permeable to ions, in an innermost winding relative to the longitudinal axis L. Therefore, the ratio of the embedded ions between two opposite sides of the first collector foil 145 can be adapted. Arrangements relating to details of the first collector foil 145 and the first region 230 will be described in more detail below in FIGS. 2A to 2B. The second collector foil 165 has a second region 260 which is perforated and, as a result, is permeable to ions, in an innermost winding relative to the longitudinal axis L. Therefore, the ratio of the embedded ions between two opposite sides of the second collector foil 165 can be adapted. Embodiments relating to details of the second collector foil 155 and the second region 260 will be described in more detail in FIGS. 2C to 2D below.

Embodiments of a detail of a first electrode 140 with a positive polarity are respectively shown in FIGS. 2A to 2B.

A detail 200 of a first electrode of positive polarity 140 of a first embodiment of the electrode winding 120 from FIG. 1 is shown schematically in FIG. 2A. The first electrode 140 has a first collector foil 145 made of an electrically conductive material, in particular aluminum. The first collector foil 145 is coated on both sides with a first electrochemical active material 150, in which ions, in particular lithium ions, can be embedded during operation of the battery cell. In one end region of the first collector foil 145 there is formed a first edge region 235 projecting beyond the coated regions. An electrical connection can be made to a first metal plate 180, in particular by welding, in this first edge region 235, via which connection an electric contact to an electric consumer can be produced through a cell housing wall. In this exemplary embodiment, the first edge region 235 has no perforation and is impermeable to ions.

The first collector foil 145 has a first region 230, which is permeable to the ions. In particular, the first region 230 has a hole structure or a perforation which is designed such that ions can pass from one side of the first collector foil 145 to the other side of the first collector foil 145 through the hole structure. Therefore, the ratio of the embedded ions between two opposite sides of the first collector foil 145 can be adapted in the installed state.

A detail 210 of a second embodiment of a coated first electrode with a positive polarity 140 is shown schematically in FIG. 2B. The first collector foil 145 has a first region 230 with a hole structure, as in FIG. 2A. The perforated first region 230 extends beyond the coated region, so that the first edge region 235 of the first collector foil 145 is likewise perforated. As a result, the electrical connection of the first metal plate 180 to a perforated edge region 235 can be made.

Embodiments of a detail of a second electrode 160 with a negative polarity are respectively shown in FIGS. 2C to 2D.

A detail 240 of a first embodiment of a second electrode of negative polarity 160 of the electrode winding 120 from FIG. 1 is shown schematically in FIG. 2C. The second electrode 160 has a second conductor foil 165 made of an electrically conductive material, in particular copper. The second conductor foil 165 is coated on both sides with a second electrochemical active material 170 in which ions, in particular lithium ions, can be embedded during operation of the battery cell. In one end region of the second collector foil 165, there is formed a second edge region 265 projecting beyond the coated regions. An electrical connection can be made to a second metal plate 190, in particular by welding, in this second edge region 265, via which connection an electric contact to an electric consumer can be produced through a cell housing wall. In this exemplary embodiment, the second edge region 265 has no perforation and is impermeable to ions.

The second conductor foil 165 has a second region 260, which is permeable to the ions. In particular, the second region 260 has a hole structure or a perforation which is formed such that ions can pass from one side of the second collector foil 165 to the other side of the second collector foil 165 through the hole structure. Therefore, the ratio of the embedded ions between two opposite sides of the second collector foil 165 can be adapted in the installed state.

A detail 250 of a second embodiment of a coated second electrode with a negative polarity 160 is shown schematically in FIG. 2D. The second collector foil 165 has a second region 260 with a hole structure, as in FIG. 2C. The perforated second region 260 extends beyond the coated region, so that the second edge region 265 of the second collector foil 165 is likewise perforated. As a result, the electrical connection of the second metal plate 190 to a perforated edge region 265 can be made.

The first region 230 and/or second region 260 which are permeable to ions can be formed on one or more radially inner or innermost windings relative to the longitudinal axis L of the corresponding first collector foil 145 or the second collector foil. Likewise, the first region 230 and/or second region 260 can be formed on windings which are arranged radially further away from the longitudinal axis L.

A perforated foil or expanded metal can be used as a conductor foil, in order to reduce mechanical stresses in a winding core which arise as a result of the extension/contraction of the active material during charging/discharging cycles.

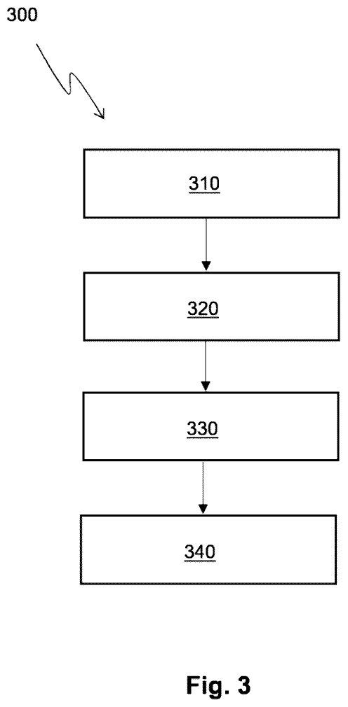

A flow chart to illustrate a preferred embodiment of a method for producing an electrode winding 120 is shown in FIG. 3.

In a first step 310 of the method, a first electrode 140 is produced, comprising the step of coating opposite sides of a first current collector 145 with a first active material 150, in which ions can be embedded, wherein the first current collector 145 has a first electrically conductive material which is impermeable to ions during operation of the energy storage cell 100, and wherein the first current collector has a first region 230 which is permeable to ions, so that the ions can pass from one to the other of the two opposite sides of the first current collector 145.

In a further step 320 of the method, a second electrode 165 is produced, comprising the step of coating opposite sides of a second current collector 165 with a second active material 170, in which the ions can be embedded, wherein the second current collector 165 has a second electrically conductive material which is impermeable to ions during operation of the energy storage cell 100.

In a further step 330 of the method, a separator 130, the first electrode 140 and the second electrode 160 are arranged in a sequence separator 130, first electrode 140, separator 130, second electrode 160.

In a further step 340 of the method, this arrangement is wound around a longitudinal axis L.

During production of the first collector foil 145 and/or the second collector foil 165 as roll stock, for example with about 1000 m per roll, it is advantageous if the distance between the perforated regions is chosen such that the roll can be tailored suitably for a plurality of planned electrode windings 120. The length of the perforated region, oriented in the roll direction, is based on how many windings are intended to be located in the region of the perforated foil.

While at least one exemplary embodiment has been described above, it should be noted that there is a large number of variations. It should also be noted that the exemplary embodiments described represent only non-limiting examples and it is not intended thereby to restrict the scope, the applicability or the configuration of the devices and methods described here. Instead, the preceding description will supply those skilled in the art with instructions for the implementation of at least one exemplary embodiment, wherein it goes without saying that various changes in the functioning and the arrangement of the elements described in an exemplary embodiment can be made without departing from the subject matter respectively defined in the dependent claims and its legal equivalents.

### LIST OF DESIGNATIONS

100 Battery cell
110 Cell housing
120 Electrode winding
130 Separator
140, 160 First and second electrode
145, 165 First and second current collector
150, 170 First and second active material
180, 190 First and second metal plate
200, 210 Respective details of a first electrode of an embodiment
240, 250 Respective details of a second electrode of an embodiment
230, 260 First and second region
235, 265 First and second edge region
300 Flow chart to illustrate a preferred embodiment of a method
310 Processing a first electrode
320 Processing a second electrode
330 Arranging a separator between the electrodes
340 Winding the electrodes and the separator about a longitudinal axis

1-15. (canceled)

16. An electrode winding for an energy storage cell, comprising:
a first electrode having a first current collector, which comprises a first electrically conductive material that is impermeable to ions during operation of the energy storage cell, wherein the first current collector has two opposite sides that are each coated with a first active material in which ions can be embedded;
a second electrode having a second current collector, which comprises a second electrically conductive material that is impermeable to ions during operation of the energy storage cell, wherein the second current collector has two opposite sides, which are each coated with a second active material in which ions can be embedded; and
a separator arranged between the first electrode and the second electrode, by which the first electrode and the second electrode are electrically insulated from one another,
wherein the first current collector has a first region which is permeable to ions, so that the ions can pass from one to the other of the two opposite sides of the first current collector.

17. The electrode winding according to claim 16,
wherein the first region is formed in a first end region of the first current collector, radially adjacent to a longitudinal axis.

18. The electrode winding according to claim 17,
wherein the first end region has a first edge region configured for making electrical contact, and which is impermeable to ions.

19. The electrode winding according to claim 17,
wherein the first end region has a first edge region configured for making electrical contact, which is permeable to ions.

20. The electrode winding according to claim 16,
wherein the first region comprises cutouts.

21. The electrode winding according to claim 16,
wherein the second current collector has a second region, which is permeable to ions, so that the ions can pass from one to the other of the two opposite sides of the second current collector.

22. The electrode winding according to claim 21,
wherein the second region is formed in an end region of the second current collector, radially adjacent to a longitudinal axis.

23. The electrode winding according to claim 22, wherein the second end region has a second edge region configured for making electrical contact, which is impermeable to ions.

24. The electrode winding according to claim 22, wherein the second end region has a second edge region configured for making electrical contact, which is permeable to ions.

25. The electrode winding according to claim 21,
wherein the second region has cutouts.

26. An energy storage cell, comprising:
a cylindrical cell housing; and
the electrode winding according to claim 16 arranged in the cylindrical cell housing.

27. A battery unit comprising:
a plurality of energy storage cells according to claim 26.

28. A system comprising:
an electric drive; and
the battery unit according to claim 27.

29. A method for producing an electrode winding for an energy storage cell, comprising:
producing a first electrode, further comprising coating opposite sides of a first current collector with a first active material in which ions can be embedded, wherein the first current collector has a first electrically conductive material which is impermeable to ions during operation of the energy storage cell, and wherein the first current collector has a first region which is permeable to ions, so that the ions can pass from one to the other of the two opposite sides of the first current collector;
producing a second electrode, further comprising coating opposite sides of a second current collector with a second active material in which the ions can be embedded, wherein the second current collector has a second electrically conductive material which is impermeable to ions during operation of the energy storage cell;
arranging a separator, the first electrode, and the second electrode in a sequence as follows: separator, first electrode, separator, second electrode; and
winding the arrangement around a longitudinal axis.

30. The method according to claim 29, comprising:
before coating the opposite sides of the first current collector, separating the first current collector from a current collector roll that is provided for a plurality of current collectors for a plurality of electrode windings, wherein the current collector roll has a first region that is permeable to the ions at equal intervals.
